(19) United States
(12) Patent Application Publication
(10) Pub. No.: US 2024/0190741 A1
(43) Pub. Date: Jun. 13, 2024

(54) PIPE CLEANING SYSTEM, WASTE WATER TREATMENT SYSTEM, AND PIPE CLEANING METHOD

(71) Applicant: Samsung Electronics Co., Ltd., Suwon-si (KR)

(72) Inventor: Gyucheol Kim, Suwon-si (KR)

(21) Appl. No.: 18/526,326

(22) Filed: Dec. 1, 2023

(30) Foreign Application Priority Data
Dec. 7, 2022 (KR) 10-2022-0170051

(51) Int. Cl. C02F 5/08; C02F 1/00

(52) U.S. Cl. CPC C02F 5/08; C02F 1/008; C02F 2103/346

(57) ABSTRACT

A pipe cleaning system includes a copper waste water supply line for supplying copper waste water, an alkali waste water supply line for supplying alkali waste water, and a connecting line connecting the copper waste water supply line and the alkali waste water supply line, wherein the copper waste water supply line includes a first pipe which is connected to a storage for storing the copper waste water and includes a first valve, and a second pipe connected to the first pipe. The alkali waste water supply line includes a third pipe that is connected to a storage for storing the alkali waste water and includes a third valve, and a fourth pipe connected to the third pipe, and the connecting line includes a connecting pipe connecting the second pipe and the third pipe to each other, and a connecting valve formed on the connecting pipe.

### CROSS-REFERENCE TO RELATED APPLICATION

This application is based on and claims priority under 35 U.S.C. § 119 to Korean Patent Application No. 10-2022-0170051, filed on Dec. 7, 2022, in the Korean Intellectual Property Office, the disclosure of which is incorporated by reference herein in its entirety.

### BACKGROUND

The present disclosure relates to a pipe cleaning system, a waste water treatment system, and a pipe cleaning method, and more particularly, to a pipe cleaning system for cleaning a pipe through which waste water flows, a waste water treatment system, and a pipe cleaning method.

Because industries have been advanced and diversified, various pollutants are released from industrial facilities. For example, waste water containing copper used in semiconductor manufacturing processes causes corrosion of a treatment apparatus, ecotoxicity, environmental pollution, etc., and thus, it is important to treat and re-use the waste water in an environmentally friendly way.

### SUMMARY

Aspects of the inventive concept provide a pipe cleaning system for cleaning a pipe by using alkali waste water, a waste water treatment system, and a pipe cleaning method.

It will be appreciated by one of ordinary skill in the art that that the objectives and effects that could be achieved with the inventive concept are not limited to what has been particularly described above and other objectives of the inventive concept will be more clearly understood from the following detailed description.

According to an aspect of the inventive concept, a pipe cleaning system includes a copper waste water supply line for supplying copper waste water, an alkali waste water supply line for supplying alkali waste water, and a connecting line connecting the copper waste water supply line and the alkali waste water supply line to each other. The copper waste water supply line includes a first pipe which is connected to a storage for storing the copper waste water and includes a first valve, and a second pipe connected to the first pipe. The alkali waste water supply line includes a third pipe that is connected to a storage for storing the alkali waste water and includes a third valve, and a fourth pipe connected to the third pipe, and the connecting line includes a connecting pipe connecting the second pipe and the third pipe to each other, and a connecting valve formed on the connecting pipe to open/close the connecting pipe.

According to an aspect of the inventive concept, there is provided a waste water treatment system.

The waste water treatment system according to an embodiment of the inventive concept includes a FAB in which semiconductor manufacturing processes are performed, a buffer tank for temporarily storing copper waste water generated in the FAB, a first line connecting the FAB to the buffer tank, a water collecting tank storing the copper waste water supplied from the buffer tank, a second line connecting the buffer tank and the water collecting tank to each other, a treatment tank for treating the copper waste water supplied from the water collecting tank, a third line connecting the water collecting tank and the treatment tank to each other, a sedimentation tank in which a sedimentation process of the copper waste water supplied from the treatment tank is performed, a fourth line connecting the treatment tank and the sedimentation tank to each other, an alkali waste water supply line connected to a storage for storing alkali waste water and providing a passage through which the alkali waste water moves, and a connecting line connecting the alkali waste water supply line and at least one of the first to fourth lines to each other. The first to fourth lines are a copper waste water supply line for supplying copper waste water.

According to an aspect of the inventive concept, there is provided a pipe cleaning method.

The pipe cleaning method according to an embodiment of the inventive concept includes checking a blockage issue in a pipe due to copper sludges in a copper waste water supply line, blocking supply of the copper waste water to the pipe, supplying alkali waste water to the pipe, and re-supplying copper waste water to the pipe, wherein the supplying of the alkali waste water to the pipe includes supplying the alkali waste water to the pipe via a connecting line connecting, to the copper waste water supply line, an alkali waste water supply line for supplying the alkali waste water.

### BRIEF DESCRIPTION OF THE DRAWINGS

Embodiments will be more clearly understood from the following detailed description taken in conjunction with the accompanying drawings in which:

FIG. 1 is a block diagram schematically illustrating a process of treating waste water, according to some embodiments;

FIG. 2 is a schematic diagram showing a copper waste water supply line and an alkali waste water supply line, according to some embodiments;

FIG. 3 is a schematic diagram showing a pipe cleaning system according to some embodiments;

FIG. 4 is a schematic diagram showing a pipe cleaning system according to some embodiments;

FIG. 5 is a schematic diagram showing a pipe cleaning system according to some embodiments; and

FIG. 6 is a flowchart for schematically describing a pipe cleaning method according to some embodiments.

### DETAILED DESCRIPTION OF THE EMBODIMENTS

Hereinafter, some embodiments will be described in detail with reference to accompanying drawings. Like reference numerals denote the same elements on the drawings, and detailed descriptions thereof are omitted.

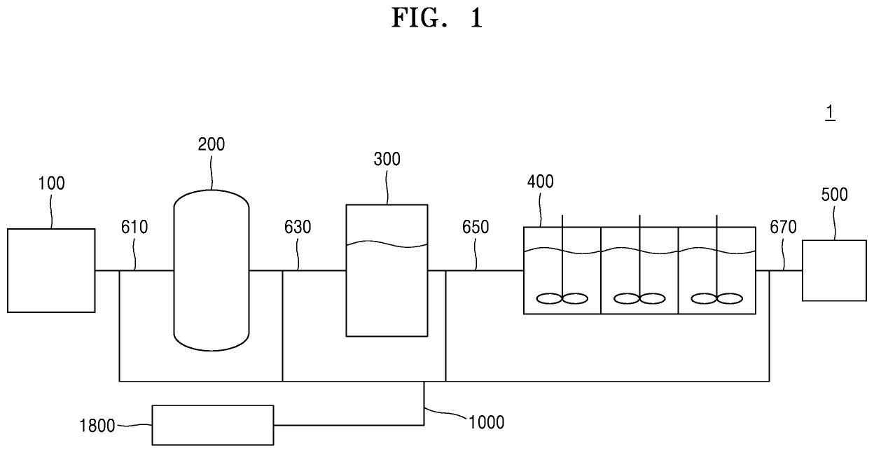

FIG. 1 is a block diagram schematically showing a waste water treatment system 1 according to some embodiments.

Referring to FIG. 1, the waste water treatment system 1 may include a FAB 100, a buffer tank 200, a water collecting tank 300, a treatment tank 400, a sedimentation tank 500, a first line 610, a second line 630, a third line 650, a fourth line 670, an alkali waste water supply line 1800, and a connecting line 1000.

The FAB (e.g., fabrication plant) 100 may be a semiconductor production line on which semiconductor manufacturing processes are carried out. An etching process, a deposition process, a development process, and a test process may be carried out on the FAB 100, and during the above processes, waste water including contaminants may be discharged.

According to some embodiments, waste water including a copper (Cu) component may be discharged from the FAB 100, and waste water including an alkali component may be discharged. Hereinafter, unless otherwise defined, the waste water including the copper component will be referred to as copper waste water, and the waste water including the alkali component will be referred to as alkali waste water. The copper waste water may be generated during a diffusion process, an etching process, a Cu chemical mechanical polishing (CMP) process, or a cleaning process, in which copper is used, from among the semiconductor manufacturing processes. The alkali waste water may be generated during one of these processes or during other processes. For example, alkali waste water as a result of a reaction during one of these processes.

The buffer tank 200 may be a storage tank in which the waste water discharged from the FAB 100 is temporarily stored. According to some embodiments, the buffer tank 200 may be configured to store the copper waste water discharged from the FAB 100.

The first line 610 may be a waste water supply line connecting the FAB 100 and the buffer tank 200 to each other. According to some embodiments, the copper waste water discharged from the FAB 100 may be supplied to the buffer tank 200 via the first line 610.

The water collecting tank 300 may be a storage tank in which the waste water is stored before being supplied to the treatment tank 400. The water collecting tank 300 may be configured to store the copper waste water. According to some embodiments, the water collecting tank 300 may include a sensor for measuring a water level of the waste water stored in the water collecting tank 300.

The second line 630 may be a waste water supply line connecting the buffer tank 200 and the water collecting tank 300 to each other. According to some embodiments, the waste water stored in the buffer tank 200 may be supplied to the water collecting tank 300 via the second line 630.

The treatment tank 400 may be formed to remove hazardous materials from the waste water supplied from the water collecting tank 300. The treatment tank 400 may remove the hazardous materials from the waste water by using a physical-chemical treatment method, a solid-liquid isolation method, a biological treatment method, a thermal treatment method, etc. The physical-chemical treatment method may denote a waste water treatment method through neutralization, pH adjustment, oxidation-reduction, extraction, adsorption, ion exchange, electric dialysis, and reverse osmosis membrane, etc. The solid-liquid isolation method may be a waste water treatment method for separately collecting floats in the waste water. The biological treatment method is a method of treating the waste water by using microbes, and the thermal treatment method may be a treatment method that evaporates the water and does not discharge the waste water.

According to some embodiments, the treatment tank 400 may include a neutralization tank, a reactor, a coagulation tank, etc.

According to some embodiments, the neutralization tank may adjust pH of the waste water by reacting with raw water of the waste water supplied to the treatment tank 400. Calcium hydroxide is injected in the reactor to react with the waste water. In the reactor, calcium hydroxide (Ca(OH)₂) dissolved in water (CITY W.) may be injected and reacts with the waste water. A deposition-type pH meter may be installed in the reactor. The pH meter measures pH in the reactor, and the injection of calcium hydroxide may be automatically performed according to a pH set value. A tube pump may be used as a calcium hydroxide injection pump, and the pump and the injection tube may be periodically or intermittently washed.

The third line 650 may be a waste water supply line connecting the water collecting tank 300 to the treatment tank 400. The waste water stored in the water collecting tank 300 may be supplied to the treatment tank 400 via the third line 650.

The sedimentation tank 500 may be formed to sediment the contaminant materials remaining in the treated waste water supplied from the treatment tank 400. In the sedimentation tank 500, solid materials and liquid may be separated. According to some embodiments, the waste water supplied to the sedimentation tank 500 may be isolated into sunken sludges and upper treated water that is purified. The treated water that is purified may be supplied to the outside, and the sunken sludges may be discharged as solid waste. In the sedimentation tank 500, an anionic polymer (POLYMER) dissolved in the water (CITY W.) is provided to act as an auxiliary coagulation agent.

A lower surface of the sedimentation tank 500 may be inclined downward from an outskirt portion toward a center portion thereof. Due to the inclination, when the sedimentation tank 500 rotates at a certain speed, the contaminant materials included in the waste water in the sedimentation tank 500 may gather at the center of the sedimentation tank 500.

The fourth line 670 may be a waste water supply line connecting the treatment tank 400 and the sedimentation tank 500 to each other. The waste water treated by the treatment tank 400 may be supplied to the sedimentation tank 500 via the fourth line 670.

According to some embodiments, the first to fourth lines 610, 630, 650, and 670 may be the copper waste water supply lines. The first to fourth lines 610, 630, 650, and 670 that are the copper waste water supply line may provide a passage through which the copper waste water passes. That is, the waste water passing through the first to fourth lines 610, 630, 650, and 670 may be the copper waste water.

The alkali waste water supply line 1800 may be a waste water supply line through which the alkali waste water in the waste water discharged from the FAB passes. According to some embodiments, the alkali waste water may include hydrogen peroxide. A concentration of the hydrogen peroxide may be in a range of about 150 ppm to about 2000 ppm. The hydrogen peroxide may be output as waste water from one of the manufacturing processes, and in some cases, the alkali waste water only includes or is refined to only include water mixed with hydrogen peroxide and possibly other chemicals, which other chemicals do not react with the copper in the copper waste water and do not change the effect that the hydrogen peroxide has on reacting with copper in the copper waste water.

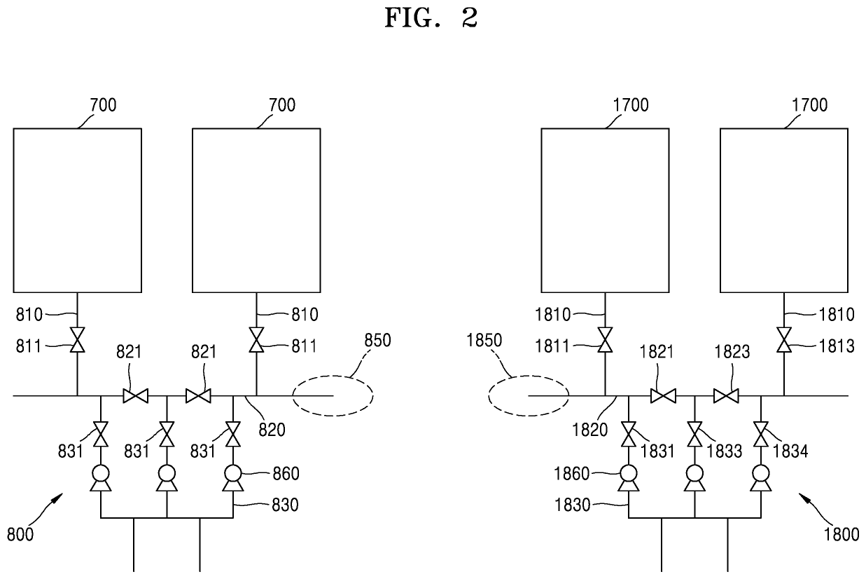

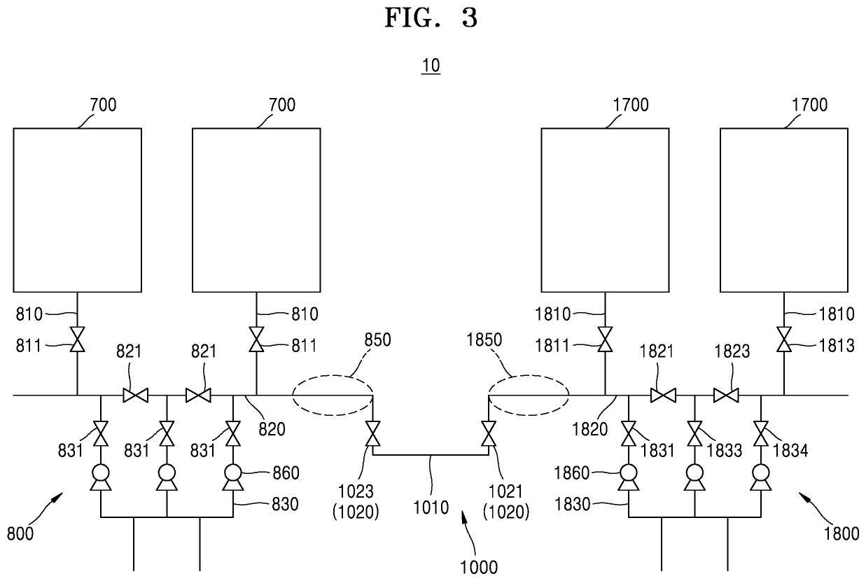

According to some embodiments, when the first to fourth lines 610, 630, 650, and 670 are the copper waste water supply lines, the alkali waste water supply line 1800 may be connected to at least one of the first to fourth lines 610, 630, 650, and 670 via the connecting line 1000. The above connection will be described below with reference to FIGS. 2 and 3.

FIG. 2 is a schematic diagram showing the copper waste water supply line 800 and the alkali waste water supply line 1800 according to embodiments. FIG. 3 is a schematic diagram showing a pipe cleaning system 10 according to some embodiments.

Referring to FIGS. 2 and 3, the pipe cleaning system 10 may include the copper waste water supply line 800, the alkali waste water supply line 1800, and the connecting line 1000. FIG. 2 does not show the connecting line 1000. Here, the copper waste water supply line 800 may correspond to one or more of the first to fourth lines 610, 630, 650, and 670 (see FIG. 1) of the waste water treatment system 1 (see FIG. 1) that treats the copper waste water as described above with reference to FIG. 1. That is, any one of, or more than one of, the first to fourth lines 610, 630, 650, and 670 (see FIG. 1) through which the copper waste water passes may be specified as the copper waste water supply line 800 of FIG. 2.

The copper waste water supply line 800 may include a first pipe 810, a first valve 811, a second pipe 820, a second valve 821, a third pipe 830, a third valve 831, and a pump 860. Certain elements are described in the singular, but can be provided in plural, as shown in FIGS. 2 and 3, for example.

The first pipe 810 may be connected to the storage 700 in which the copper waste water is stored. The storage 700 may correspond to the buffer tank 200 (see FIG. 1) or the water collecting tank 300 (see FIG. 1) described above with reference to FIG. 1, but is not limited thereto. The storage 700 may denote the treatment tank 400 (see FIG. 1). Broadly speaking, the storage 700 may denote a space in which the copper waste water is stored or treated while the waste water treatment process is carried out in the waste water treatment system 1 (see FIG. 1). There may be a plurality of storages 700. The plurality of storages 700 may each store the copper waste water independently from one another. For example, the storage 700 may represent one of the components of FIG. 1, such as the buffer tank 200, the water collecting tank 300, the treatment tank 400, or the sedimentation tank 500.

The first pipe 810 may be connected to the storage 700 and the second pipe 820, and may provide a passage through which the copper waste water stored in the storage 700 is moved to the second pipe 820. The first pipe 810 may provide the copper waste water to the second pipe 820.

The first valve 811 may be configured to adjust opening/closing of the first pipe 810. The first valve 811 may adjust a flow rate of the waste water passing through the first pipe 810. Therefore, when the first valve 811 is locked, the copper waste water may not be supplied from the storage 700 to the first pipe 810.

The second pipe 820 may be connected to the first pipe 810 and the third pipe 820, and may provide a passage through which the copper waste water passing through the first pipe 810 is supplied to the third pipe 830. According to some embodiments, the second pipe 820 may include an end portion 850. The end portion 850 may denote an end portion extending from the second pipe 820 and not being connected to another pipe of the copper waste water supply line 800. The end portion 850 may be a part that extends from the second pipe 820 without being connected to the first pipe 810 or the third pipe 830 as shown in FIG. 2.

The second valve 821 may be configured to adjust opening/closing of the second pipe 820. The second valve 821 may adjust a flow rate of the second pipe 820. According to some embodiments, a plurality of second valves 821 may be provided. According to some embodiments, the plurality of second valves 821 may be located between respective sections where the second pipe 820 is connected to the other pipes.

The third pipe 830 may be connected to the second pipe 820. The third pipe 830 may provide a passage through which the copper waste water supplied from the second pipe 820 is moved. The third pipe 830 may be connected to a place where a next treatment process of the copper waste water is carried out.

The third pipe 830 may include a plurality of branch pipes, and each of the branch pipes may include the third valve 831 and the pump 860. A moving passage of a fluid flowing through the third pipe 830 may be set via the third valve 831 and the pump 860.

The alkali waste water supply line 1800 may include a fourth pipe 1810, a fourth valve 1811, a fifth pipe 1820, a fifth valve 1821, a sixth pipe 1830, a pump 1860, and a sixth valve 1831. Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

The fourth pipe 1810 may be connected to a storage 1700 storing alkali waste water and a fifth pipe 1820. The storage 1700 may store alkali waste water during the treatment process of the alkali waste water. There may be a plurality of storages 1700, and each of the plurality of storages 1700 may be independently formed. The storages 1700 may be connected to different parts of a fabrication plant (FAB) where alkali waste water is generated.

The number of fourth pipes 1810 may be equal to that of the storages 1700. The plurality of fourth pipes 1810 may each have a valve formed thereon. According to some embodiments, a fourth valve 1811 may be formed on a pipe, from among the plurality of fourth pipes 1810, which is closest to the connecting pipe 1010 (in FIG. 3). For example, the fourth valve 1811 may be arranged to be closest to the connecting line 1000, from among the valves 1811 and 1813 formed on the fourth pipes 1810.

The fifth pipe 1820 may be connected to the fourth pipes 1810 and the sixth pipe 1830, and may provide a passage through which the alkali waste water passing through the fourth pipes 1810 may be supplied to the sixth pipe 1830. According to some embodiments, the fifth pipe 1820 may include an end portion 1850. The end portion 1850 may denote an end portion extending from the fifth pipe 1820 and not being connected to another pipe of the alkali waste water supply line 1800. That is, the end portion 1850 may be a part that extends from the fifth pipe 1820 without being connected to the fourth pipe 1810 or the sixth pipe 1830 as shown in FIG. 2.

The fifth pipe 1820 may have a plurality of valves formed thereon. According to some embodiments, the fifth valve 1821 may be arranged closest to the connecting line 1000 (e.g., in FIG. 3), from among the plurality of valves 1821 and 1823 formed on the fifth pipe 1820.

The sixth pipe 1830 may be connected to the fifth pipe 1820. The sixth pipe 1830 may provide a passage through which the alkali waste water supplied from the fifth pipe 1820 is moved. The sixth pipe 1830 may be connected to a place where a next treatment process of the alkali waste water is carried out.

The sixth pipe 1830 may include a plurality of branch pipes, and each of the branch pipes may include a valve and a pump 1860. For example, as shown in FIG. 3, the sixth pipe 1830 may include three branched lines, and a plurality of valves 1831, 1833, and 1834.

According to some embodiments, the sixth valve 1831 may be arranged closest to the connecting pipe 1010, from among the plurality of valves 1831, 1833, and 1834.

When the fifth valve 1821 and the sixth valve 1831 are locked (closed) while the fourth valve 1811 is opened, some of the alkali waste water flowing in the fourth pipes 1810 from the storages 1700 may flow into the connecting pipe 1010. In the storage 1700 that is closest to the connecting pipe 1010, from among the alkali waste water storages 1700 of FIG. 3, the alkali waste water passing through the fourth pipe 1810 on which the fourth valve 1811 is formed may flow only into the connecting pipe 1010 when the fifth valve 1821 and the sixth valve 1831 are locked.

Therefore, some of the alkali waste water passing through the alkali waste water supply line 1800 may be supplied to the connecting line 1000 by adjusting opening/closing of the fifth valve 1821 and the sixth valve 1831.

The connecting line 1000 may connect the copper waste water supply line 800 and the alkali waste water supply line 1800 to each other. Some of the alkali waste water passing through the alkali waste water supply line 1800 may be supplied to the copper waste water supply line 800 via the connecting line 1000.

The connecting line 1000 may include the connecting pipe 1010 and a connecting valve 1020. The connecting pipe 1010 may be connected respectively to one of the pipes in the copper waste water supply line 800 and one of the pipes in the alkali waste water supply line 1800. According to some embodiments, the connecting pipe 1010 may be connected respectively to the second pipe 820 and the fifth pipe 1820. The connecting pipe 1010 may include at least one of polyvinyl chloride (PVC) and polyethylene (PE). When the connecting pipe 1010 includes at least one of the PVC and PE, corrosion due to the alkali waste water and degradation in durability may be prevented.

According to some embodiments, the connecting pipe 1010 may be connected to each of the end portion 850 of the second pipe 820 and the end portion 1850 of the fifth pipe 1820. Because the connecting pipe 1010 is connected to the end portions 850 and 1850, the connecting pipe 1010 may be connected to the copper waste water supply line 800 and the alkali waste water supply line 1800 without performing an additional process such as welding. Therefore, the connecting line 1000 may be easily connected to the copper waste water supply line 800 and the alkali waste water supply line 1800.

The connecting valve 1020 may be configured to open/close the connecting pipe 1010. The connecting valve 1020 may be configured to adjust the flow rate of the waste water passing through the connecting pipe 1010. There may be a plurality of connecting valves 1020. The connecting valves 1020 may include a main valve 1021 and an auxiliary valve 1023. The main valve 1021 may be a valve, from among the connecting valves 1020, adjacent to the alkali waste water supply line 1800, and the auxiliary valve 1023 may be a valve, from among the connecting valves 1020, adjacent to the copper waste water supply line 800.

According to some embodiments, the main valve 1021 may include an automatic valve (e.g., computer controlled). Therefore, the main valve 1021 may automatically control the opening/closing of the connecting valves 1020.

The auxiliary valve 1023 may be in a constantly open state. That is, the auxiliary valve 1023 may be in a constantly open state so that the alkali waste water passes through the connecting pipe 1010 into the copper waste water supply line 800. However, when there is an issue on the main valve 1021, the auxiliary valve 1023 may block the alkali waste water passing through the connecting pipe 1010. That is, when the main valve 1021 has an issue, the auxiliary valve 1023 may be switched into a closed state so that the alkali waste water may not pass through the connecting pipe 1010 into the copper waste water supply line 800. According to some embodiments, the auxiliary valve 1023 may be a manual valve. Because the auxiliary valve 1023 includes the manual valve, even when the main valve 1021 breaks, the auxiliary valve 1023 may be manually closed (e.g., by an operator) so as to prevent over-supply of the alkali waste water into the copper waste water supply line 800.

When the copper waste water passes through pipes of the copper waste water supply line 800, sludge may be generated. The sludges generated in the pipe interfere with the flow of the copper waste water, and may increase the water level in the storage 700.

The pipe cleaning system 10 according to aspects of the inventive concept may supply some of the alkali waste water moving along the alkali waste water supply line 1800 to the copper waste water supply line 80 via the connecting pipe 1010.

When the alkali waste water is supplied to the copper waste water supply line 800, the sludge formed in the pipes of the copper waste water supply line 800 may be removed. Hydrogen peroxide included in the alkali waste water may remove the sludge from the pipes of the copper waste water supply line 800.

For example, when the alkali waste water including hydrogen peroxide is supplied from the alkali waste water supply line 1800 and the connecting line 1000, reactions according to formula 1 and formula 2 below may occur.

$$\begin{matrix}{H}_{2} {O}_{2} -> 2 ∘ OH & formula 1 \\ 2 OH + R -> ∘ R + {H}_{2} O + \frac{1}{2} {O}_{2} & formula 2\end{matrix}$$

In formula 1 and formula 2 above, °OH may denote a free radical generated when hydrogen peroxide is degraded, R may denote copper sludge included in the waste water including, for example, a semiconductor copper pad, a copper polishing agent, etc. and R may denote a free radical generated through formula 2 above.

The sludge formed in the pipes of the copper waste water supply line 800 may be removed through the reaction of formula 1 and formula 2 above. When the sludge is removed, the connecting valve 1020 is closed to prevent the alkali waste water from being supplied to the copper waste water supply line 800.

For example, whether to supply/block the alkali waste water to/from the copper waste water supply line 800 may be set via the connecting valve 1020, and the moving passage and the flow rate of the alkali waste water supplied to the copper waste water supply line 800 via the fifth valve 1821 and the sixth valve 1831 may be determined. As described above, certain valves may be provided in plural, but may be referred to in the singular. For example, connecting valve 1020 may be a valve that includes two sub-valves 1021 and 1023 that together form the connecting valve 1020. Each sub-valve 1021 and 1023 may be described as a valve (and may be a single valve), and the connecting valve 1020 may be described as a valve and may be a composite valve including a plurality of sub-valves.

Because the sludge is removed by the chemical reaction using the alkali waste water, the sludge may be easily removed without performing manual operation, and casualty events that may occur during the manual operation may be prevented.

Also, because some of the alkali waste water passing through the alkali waste water supply line 1800 is used, there is no need to separately purchase a solution including hydrogen peroxide, and the alkali waste water generated during the semiconductor manufacturing processes or another manufacturing process is used. Thus, there may be a noticeable economic effect.

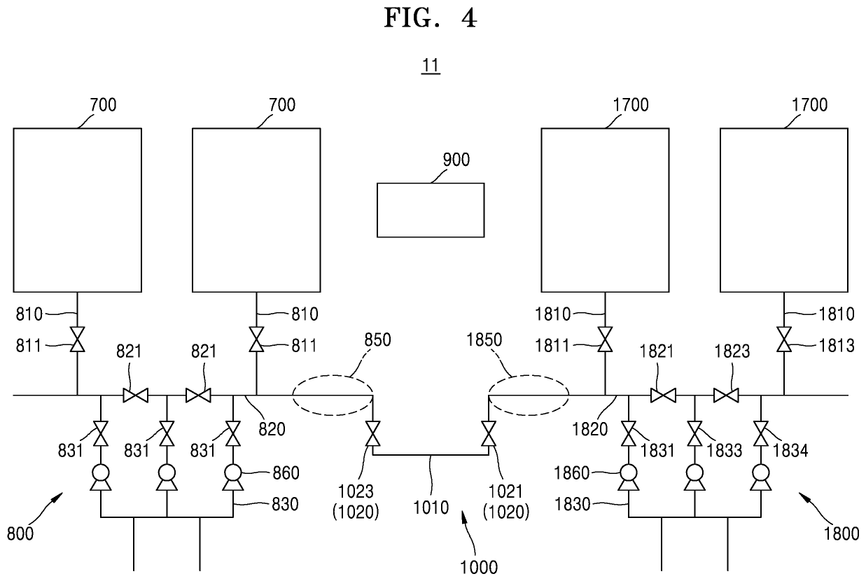

FIG. 4 is a schematic diagram showing a pipe cleaning system 11 according to some embodiments. Hereinafter, redundant descriptions between the pipe cleaning system 10 of FIG. 3 and the pipe cleaning system 11 of FIG. 4 are omitted, and differences are described below.

Referring to FIG. 4, the pipe cleaning system 11 may include the copper waste water supply line 800, the alkali waste water supply line 1800, and the connecting line 1000. The copper waste water supply line 800 may include the first pipe 810, the first valve 811, the second pipe 820, the second valve 821, the third pipe 830, the third valve 831, and the pump 860. The alkali waste water supply line 1800 may include the fourth pipe 1810, the fourth valve 1811, the fifth pipe 1820, the fifth valve 1821, the sixth pipe 1830, the pump 1860, and the sixth valve 1831. The connecting line 1000 may include the connecting pipe 1010 and the connecting valve 1020.

According to some embodiments, the first valve 811, the main valve 1021, the fourth valve 1811, the fifth valve 1821, and the sixth valve 1831 may include or be automatic valves. In some embodiments, the first valve, the main valve 1021, the fourth valve 1811, the fifth valve 1821, and the sixth valve 1831 may be butterfly automatic valves.

According to some embodiments, the pipe cleaning system 11 may further include a controller 900. The controller 900 may be configured to adjust the opening/closing of the first valve 811, the main valve 1021, the fourth valve 1811, the fifth valve 1821, and the sixth valve 1831. The controller 900 may adjust the opening/closing of the first valve 811, the main valve 1021, the fourth valve 1811, the fifth valve 1821, and the sixth valve 1831 so that some of the alkali waste water passing through the alkali waste water supply line 1800 is supplied to the copper waste water supply line 800 by adjusting the opening/closing of the first valve 811, the main valve 1021, the fourth valve 1811, the fifth valve 1821, and the sixth valve 1831. Therefore, the supply and block of the alkali waste water to the copper waste water supply line 800 may be automatically adjusted by the controller 900.

For example, when it is identified that there is a sludge issue in the pipes of the copper waste water supply line 800 of the storage 700, the controller 900 may generate a signal for adjusting the opening/closing of the first valve 811, the main valve 1021, the fourth valve 1811, the fifth valve 1821, and the sixth valve 1831 so that the alkali waste water may be automatically supplied to the pipes.

Also, when the sludge is removed due to the alkali waste water, the controller 900 may generate a signal for adjusting the opening/closing of the first valve 811, the main valve 1021, the fourth valve 1811, the fifth valve 1821, and the sixth valve 1831 so as to automatically block the supply of the alkali waste water to the copper waste water supply line 800.

The controller 900 may be implemented as hardware, firmware, software, or any combination thereof. For example, the controller 900 may include a computing device such as a work station computer, a desktop computer, a tablet computer, etc. The controller 900 may include a simple controller, a complicated processor such as a micro-processor, a central processing unit (CPU), a graphic processing unit (GPU), etc., a processor including software, exclusive hardware, or firmware. The controller 900 may be implemented by a universal computer or application specific hardware such as a digital signal processor (DSP), a field programmable gate array (FPGA), an application specific integrated circuit (ASIC), etc. The controller 900 may be implemented as commands stored on a machine-readable medium that may be read and executed by one or more processors. Here, the machine-readable medium may include an arbitrary mechanism for storing and/or transmitting information in the form of being readable by a machine (e.g., computing device). For example, the machine-readable medium may include read-only memory (ROM), a random access memory (RAM), a magnetic disk storage medium, an optical storage medium, flash memory devices, electric, optical, acoustic, or other forms of radio signals (e.g., carrier wave, infrared signal, digital signal, etc.), and any other signals.

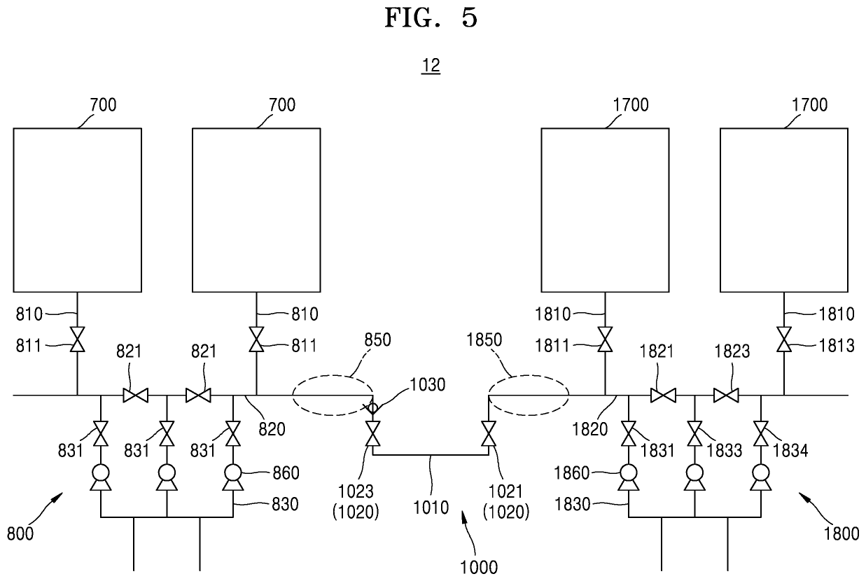

FIG. 5 is a schematic diagram showing a pipe cleaning system 12 according to some embodiments. Hereinafter, redundant descriptions between the pipe cleaning system 10 of FIG. 3 and the pipe cleaning system 12 of FIG. 5 are omitted, and differences are described below.

Referring to FIG. 5, the pipe cleaning system 12 may include the copper waste water supply line 800, the alkali waste water supply line 1800, and the connecting line 1000. The copper waste water supply line 800 may include the first pipe 810, the first valve 811, the second pipe 820, the second valve 821, the third pipe 830, the third valve 931, and the pump 860. The alkali waste water supply line 1800 may include the fourth pipe 1810, the fourth valve 1811, the fifth pipe 1820, the fifth valve 1821, the sixth pipe 1830, a pump 1860, and the sixth valve 1831. The connecting line 1000 may include the connecting pipe 1010 and the connecting valve 1020.

According to some embodiments, the connecting line 1000 may further include a check valve 1030. The check valve 1030 may be formed on the connecting pipe 1010, and may prevent the alkali waste water supplied from the alkali waste water supply line 1800 to the copper waste water supply line 800 from flowing backward. Also, the check valve 1030 may prevent the copper waste water from being supplied from the copper waste water supply line 800 to the alkali waste water supply line 1800. The check valve 1030 may be arranged adjacent to the copper waste water supply line 800. According to some embodiments, the check valve 1030 may be formed closer to the copper waste water supply line 800 than the auxiliary valve 1023.

When the alkali waste water is supplied to the copper waste water supply line 800, a first valve 811 is locked to block the supply of the copper waste water to the copper waste water supply line 800 as described later. However, the copper waste water remaining in the copper waste water supply line 800 may be supplied to the alkali waste water supply line 1800 along the connecting line 1000. However, when the connecting line 1000 further includes the check valve 1030, the supply of the copper waste water from the copper waste water supply line 800 to the alkali waste water supply line 1800 may be prevented.

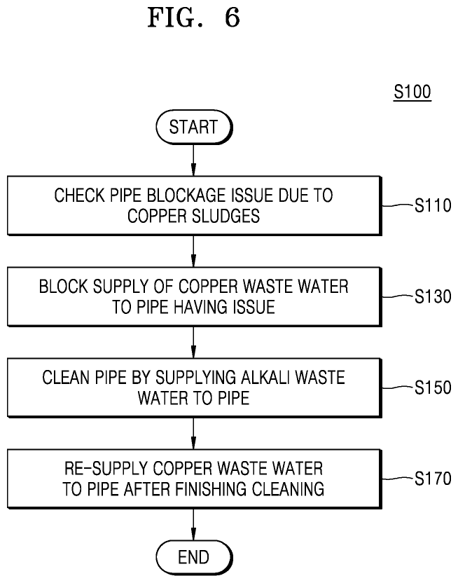

FIG. 6 is a flowchart for schematically describing a pipe cleaning method according to some embodiments. Hereinafter, the pipe cleaning method according to some embodiments will be described in detail below with reference to FIGS. 4 and 6. Also, descriptions provided above with reference to FIGS. 1 to 5 are omitted.

Referring to FIGS. 4 and 6, the pipe cleaning method (S100) may include checking a pipe blockage issue due to the copper sludges (S110), blocking the supply of the copper waste water to the pipe having the issue (S130), cleaning the pipe by supplying the alkali waste water to the pipe (S150), and re-supplying the copper waste water to the pipe after finishing the cleaning (S170).

In operation S110, the pipe blockage issue may be checked through whether the water level in the storage 700 storing the copper waste water rises, whether the supply amount of the copper waste water to the copper waste water supply line is reduced, etc. Sensors connected to the controller 900 may be used for this purpose (e.g., sensors that detect a water level or detect a flow rate or flow volume). According to some embodiments, when increase in the water level exceeds a certain level or the copper waste water supply amount is equal to or less than a certain numerical value, the controller 900 may transfer an alarm signal to a central control system. Here, a position of the pipe in which blockage occurs in the copper waste water supply line 800 may be searched for and determined (e.g., based on which sensor sent a signal to the controller 900).

After finding the pipe blockage in operation S110, the supply of copper waste water to the copper waste water supply line 800 is blocked in operation S130. Here, the block may be carried out via the first valve 811. The first valve 811 may be switched into a closed state and blocks the supply of the copper waste water from the storage 700. Here, the first valve 811 may be an automatic valve, and the first valve 811 may be switched into the closed state according to the signal from the controller 900. In one embodiment, all of the first valves 811 are switched into the closed state upon detection of a supply line blockage. Because the first valves 811 are switched into the closed state, the supply of the copper waste water to the second pipe 820 and the third pipe 830 may be blocked.

After that, the fifth valve 1821 and the sixth valve 1831 are closed so that some of the alkali waste water passing through the alkali waste water supply line 1800 may proceed toward the connecting pipe. For example, when the fifth valve 1821 and the sixth valve 1831 are closed, the alkali waste water passing through the fourth pipe 1810 on which the fourth valve 1811 is formed may flow toward the connecting line 1000.

The fifth valve 1821 and the sixth valve 1831 may include or be automatic valves, and opening/closing of the fifth valve 1821 and the sixth valve 1831 may be carried out according to the signal from the controller 900.

In operation S150, the alkali waste water is supplied to the pipe in which the blockage issue occurs. Here, the connecting valve 1020 is switched to an open state, and the alkali waste water may be supplied to the copper waste water supply line 800. The alkali waste water supplied to the copper waste water supply line 800 may remove the sludge through chemical reaction with the sludge formed in the pipe. For example, different combinations of valves may be opened and closed to allow for the alkali waste water to reach specific sections of the copper waste water supply line 800 and to be blocked from reaching others.

According to some embodiments, the alkali waste water and the sludge may react with each other for about 20 seconds to about 5 minutes. Because hydrogen peroxide in the alkali waste water and the sludge react fast, the sludge may be removed by reacting the alkali waste water with the sludge for a short period of time as above.

In operation S170, after finishing the cleaning of the pipe, the copper waste water is re-supplied to the copper waste water supply line 800. According to some embodiments, the connecting valve 1020 is switched to the closed state again, and the first valve 811 is switched into the open state. After that, the fifth valve 1821 and the sixth valve 1831 are switched into the open state, so as to re-supply the copper waste water to the copper waste water supply line 800 and the alkali waste water to the alkali waste water supply line 1800.

According to some embodiments, the connecting valve 1020, the first valve 811, the fifth valve 1821, and the sixth valve 1831 may be automatic valves, and switching of the connecting valve 1020, the first valve 811, the fifth valve 1821, and the sixth valve 1831 may be carried out by the signal from the controller.

The various pipes or lines described herein may be connected to adjacent pipes or lines using pipe connectors—for example having elbow shapes or T shapes. Using FIG. 3 as an example, the connecting pipe 1010 may be connected to the second pipe 820 using an elbow connector, and may be connected to the fifth pipe 1820 using an elbow connector. The first pipe 810 may be connected to the second pipe 820 using a T-shaped connector. Other connectors may be similarly used to connect the pipes shown in the various embodiments based on the shapes formed in the drawings, for example. In addition, valves may be between portions of a pipe—for example, a first valve 811 may be formed between two portions of each first pipe 810. Other valves may be similarly connected based on the depictions in the drawings. However, other arrangements than those depicted in the drawings may be used as well. Pipes may be described herein as connected to other pipes, in which case, the connection does not necessarily require an adjacent or direct connection. However, pipes described as adjacent, or adjacently connected to other pipes are connected to those other pipes directly, without any other pipes therebetween (though they may be connected to each other with a connector, such as an elbow shaped or T-shaped connector).

While the inventive concept has been particularly shown and described with reference to embodiments thereof, it will be understood that various changes in form and details may be made therein without departing from the spirit and scope of the following claims.

What is claimed is:

1. A pipe cleaning system comprising:
a copper waste water supply line for supplying copper waste water;
an alkali waste water supply line for supplying alkali waste water; and
a connecting line connecting the copper waste water supply line and the alkali waste water supply line to each other,
wherein the copper waste water supply line comprises:
a first pipe which is connected to a storage for storing the copper waste water and includes a first valve; and a second pipe connected to the first pipe,
wherein the alkali waste water supply line comprises:
a third pipe that is connected to a storage for storing the alkali waste water and includes a third valve; and a fourth pipe connected to the third pipe, and
wherein the connecting line comprises:
a connecting pipe connecting the second pipe and the third pipe to each other; and a connecting valve formed on the connecting pipe to open/close the connecting pipe.

2. The pipe cleaning system of claim 1, wherein:
the second pipe and the third pipe each includes an end portion, and
the connecting pipe is coupled to each of the end portion of the second pipe and the end portion of the third pipe.

3. The pipe cleaning system of claim 1, wherein:
the connecting valve includes: a main valve formed at a side of the third pipe; and an auxiliary valve formed at a side of the second pipe.

4. The pipe cleaning system of claim 3, wherein:
the copper waste water supply line further comprises:
a fifth pipe connected to the second pipe, and
the alkali waste water supply line further comprises:
a sixth pipe connected to the third pipe and including a fourth valve; and a seventh pipe connected to the sixth pipe and including a fifth valve.

5. The pipe cleaning system of claim 4, wherein
each of the first valve, the main valve, the third valve, the fourth valve, and the fifth valve is an automatic valve.

6. The pipe cleaning system of claim 5, wherein:
the automatic valves are butterfly automatic valves.

7. The pipe cleaning system of claim 5, further comprising:
a controller configured to adjust opening/closing of the first valve, the main valve, the third valve, the fourth valve, and the fifth valve.

8. The pipe cleaning system of claim 3, wherein:
the auxiliary valve is a manual valve.

9. The pipe cleaning system of claim 1, wherein:
the connecting line further comprises a check valve that prevents the alkali waste water supplied from the alkali waste water supply line to the copper waste water supply line from flowing backward.

10. The pipe cleaning system of claim 1, wherein:
the alkali waste water includes hydrogen peroxide.

11. The pipe cleaning system of claim 1, wherein:
the connecting pipe includes at least one of polyvinyl chloride (PVC) and polyethylene (PE).

12. A waste water treatment system comprising:
a fabrication plant (FAB) in which semiconductor manufacturing processes are performed;
a buffer tank for temporarily storing copper waste water generated in the FAB;
a first line connecting the FAB and the buffer tank to each other;
a water collecting tank storing the copper waste water supplied from the buffer tank;
a second line connecting the buffer tank and the water collecting tank to each other;
a treatment tank for treating the copper waste water supplied from the water collecting tank;
a third line connecting the water collecting tank and the treatment tank to each other;
a sedimentation tank in which a process of sedimentation of the copper waste water supplied from the treatment tank is performed;
a fourth line connecting the treatment tank to the sedimentation tank;
an alkali waste water supply line connected to a storage for storing alkali waste water, and providing a passage through which the alkali waste water moves; and
a connecting line connecting the alkali waste water supply line to at least one of the first to fourth lines,
wherein the first to fourth lines are copper waste water supply lines for supplying copper waste water.

13. The waste water treatment system of claim 12, wherein:
the connecting line connects the third line and the alkali waste water supply line to each other.

14. The waste water treatment system of claim 12, wherein:
the copper waste water supply lines comprise: a first pipe including a first valve; and a second pipe connected to the first pipe,
the alkali waste water supply line comprises: a third pipe including a third valve; and a fourth pipe connected to the third pipe, and
the connecting line further comprises: a connecting pipe connecting the second pipe and the third pipe to each other; and a connecting valve configured to open/close the connecting pipe.

15. The waste water treatment system of claim 14, wherein:
the copper waste water supply lines further comprise:
a fifth pipe connected to the second pipe, and
the alkali waste water supply line further comprises:
a sixth pipe connected to the third pipe and including a fourth valve; and a seventh pipe connected to the sixth pipe and including a fifth valve,
the connecting valve includes: a main valve formed at a side of the third pipe; and an auxiliary valve formed at a side of the second pipe, and
the first valve, the main valve, the third valve, the fourth valve, and the fifth valve are automatic valves.

16. The waste water treatment system of claim 15, further comprising:
a controller configured to adjust opening/closing of the first valve, the main valve, the third valve, the fourth valve, and the fifth valve.

17. The waste water treatment system of claim 15, wherein:
the auxiliary valve is a manual valve.

18. A pipe cleaning method comprising:
checking a blockage issue in a pipe due to copper sludge in a copper waste water supply line;
blocking supply of the copper waste water to the pipe;
supplying alkali waste water to the pipe; and
re-supplying copper waste water to the pipe,
wherein the supplying of the alkali waste water to the pipe comprises:
supplying the alkali waste water to the pipe via a connecting line connecting, to the copper waste water supply line, an alkali waste water supply line for supplying the alkali waste water.

19. The pipe cleaning method of claim 18, wherein:
the supplying of the alkali waste water to the pipe is carried out for 20 seconds to 5 minutes.

20. The pipe cleaning method of claim 18, wherein:
the blocking of the supply of the copper waste water to the pipe further comprises:
switching a first valve to a closed state,
the supplying of the alkali waste water to the pipe further comprises:
switching a connecting valve of the connecting line into an open state, and switching a second valve and a third valve of the alkali waste water supply line into a closed state, and
the re-supplying of copper waste water to the pipe comprises switching the connecting valve into the closed state, switching the first valve into the open state, and switching the second valve and the third valve into the open state.
